(19) United States
(12) Patent Application Publication
(10) Pub. No.: US 2026/0061648 A1
(43) Pub. Date: Mar. 5, 2026

(54) CHARGING STRUCTURE FOR HAIR GROOMING DEVICE

(71) Applicant: SHENZHEN PETABOO TECHNOLOGY CO., LTD., SHENZHEN (CN)

(72) Inventor: BOCHAO XU, SHENZHEN (CN)

(21) Appl. No.: 19/280,347

(22) Filed: Jul. 25, 2025

(30) Foreign Application Priority Data
Aug. 27, 2024 (CN) 202422094659.X

(51) Int. Cl. B26B 19/38; H02J 7/00

(52) U.S. Cl. CPC B26B 19/3873; H02J 7/731

(57) ABSTRACT

A charging structure for a hair grooming device is provided, including a charging base, a grooming device host, and an elastic mechanism. The charging base is provided with a first electrical contact configured to electrically connect to an external power source. The grooming device host is provided with a built-in power supply, and a second electrical contact electrically connected to the built-in power supply. When the first electrical contact contacts the second electrical contact, the elastic mechanism applies elastic adjustment to the first electrical contact or the second electrical contact, thereby establishing an elastic connection between the first electrical contact and the second electrical contact. With the structural configuration described above, the grooming device host operates without needing to connect to the mains power supply. Paired with a charging base for recharging and the elastic adjustment provided by the elastic device, it offers significant user convenience.

### TECHNICAL FIELD

The present disclosure relates to a technical field of pet supplies, and in particular to a charging structure of a hair grooming device.

### BACKGROUND

Pet hair grooming devices have emerged in recent years as a product category designed to trim and remove pet hair, with integrated suction mechanisms collecting the dislodged hair. With continuous product iterations, hair grooming devices have increasingly prioritized portable designs. In typical implementations, pet grooming devices generally utilize power cords connected to mains electricity for operation. As a result, existing grooming devices are inconvenient to operate, which hinders the design of portable grooming devices.

### SUMMARY

In order to overcome shortcomings in the prior art, the present disclosure provides a charging structure for a hair grooming device including a charging base, a grooming device host, and an elastic mechanism. The charging base is provided with a first electrical contact configured to electrically connect to an external power source. The grooming device host is provided with a built-in power supply and a second electrical contact. The second electrical contact is electrically connected to the built-in power supply. When the first electrical contact of the charging base contacts the second electrical contact of the grooming device host, the elastic mechanism applies elastic adjustment to the first electrical contact or the second electrical contact, thereby establishing an elastic connection between the first electrical contact and the second electrical contact.

The elastic mechanism is disposed on the charging base, and the elastic mechanism is configured to apply the elastic adjustment to the first electrical contact to establish the elastic connection with the second electrical contact.

The charging base includes a first circuit board disposed on the elastic mechanism, the first electrical contact is arranged on the first circuit board, and the first circuit board is configured to electrically connected to the external power source, thereby enabling electrical connection of the first electrical contact and the external power source.

The elastic mechanism includes a base member and a cover member, the cover member covers and secures the first circuit board to the base member, the cover member defines a first through hole, the first electrical contact protrudes through the first through hole to be exposed outside the cover member.

A sidewall of the base member is provided with a snap-fit protrusion, a sidewall of the cover member is provided with a snap-fit aperture, and the snap-fit protrusion interlocks with the snap-fit aperture to connect the base member and the cover member.

The elastic mechanism further includes a spring, the charging base defines an installation cavity, the base member is disposed within the installation cavity, a first end of the spring abuts against the base member, a second end of the spring abuts against a bottom wall of the installation cavity, the installation cavity defines an opening, and the cover member protrudes through the opening to be exposed outside the installation cavity.

The base member is provided with a positioning post, and the first end of the spring is sleeved over the positioning post.

An inner wall of the opening is provided with a stopper block, an outer wall of the cover member is provided with a stopper slot, and the stopper block is disposed within the stopper slot to limit an elastic adjustment travel of the spring.

The grooming device host includes a second circuit board, the second electrical contact is disposed on the second circuit board, and the second circuit board is electrically connected to the built-in power supply, thereby enabling electrical connection of the second electrical contact and built-in power supply.

The grooming device host defines a second through hole, the second electrical contact protrudes through the second through hole to be exposed outside the grooming device host; an annular positioning protrusion is disposed on the grooming device host around a periphery of the second through hole, and the annular positioning protrusion encloses a positioning space having a shape complementary to a shape of the cover member.

The beneficial effects of the present disclosure are as follows. Through the above structural configuration, a built-in power supply is integrated into the grooming device host, thereby providing electricity to electronic components within the host, eliminating the need for external mains electricity connection. This design simplifies the structure and enhances operational convenience. Additionally, the charging base facilitates efficient charging of the grooming device host. During use, bringing the first electrical contact of the charging base into contact with the second electrical contact of the grooming device host enables charging of the grooming device host, thereby providing a convenient charging solution. Furthermore, through the arrangement of the elastic mechanism, elastic adjustment is enabled when the first electrical contact and the second electrical contact come into contact, ensuring stable and reliable electrical contact there between.

### BRIEF DESCRIPTION OF DRAWINGS

In order to more clearly illustrate embodiments of the present disclosure or technical solutions in the prior art, accompanying drawings required in the embodiments or the prior art are briefly introduced below, and obviously, the accompanying drawings in following description are merely some embodiments of the present disclosure, and for those who skilled in the art, other drawings may also be obtained according to structures shown in the accompanying drawings without creative efforts.

FIG. 1 is a structural schematic diagram according to an exemplary embodiment of the present disclosure.

FIG. 2 is an exploded schematic diagram of FIG. 1.

FIG. 3 is a schematic diagram showing the second electrical contact of the grooming device host according to an exemplary embodiment of the present disclosure.

FIG. 4 is a cross-sectional view according to an exemplary embodiment of the present disclosure.

FIG. 5 is an enlarged view of portion A shown in FIG. 4.

FIG. 6 is a schematic diagram showing the built-in power supply of the grooming device host according to an exemplary embodiment of the present disclosure.

FIG. 7 is an enlarged view of portion B shown in FIG. 6.

FIG. 8 is an assembly schematic diagram of the base member and cover member according to an exemplary embodiment of the present disclosure.

FIG. 9 is an exploded schematic diagram of the base member and cover member at a first angle according to an exemplary embodiment of the present disclosure.

FIG. 10 is an exploded schematic diagram of the base member and cover member at a second angle according to an exemplary embodiment of the present disclosure.

### DETAILED DESCRIPTION OF EMBODIMENTS

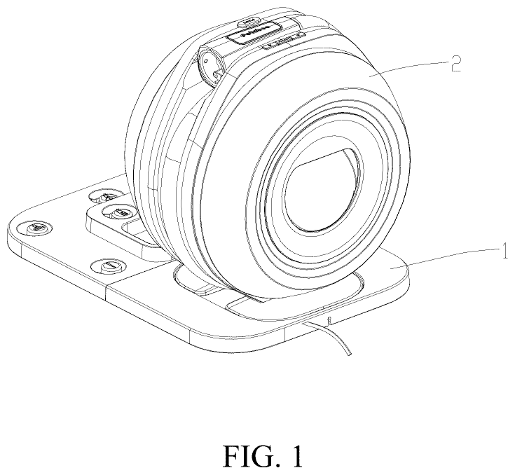

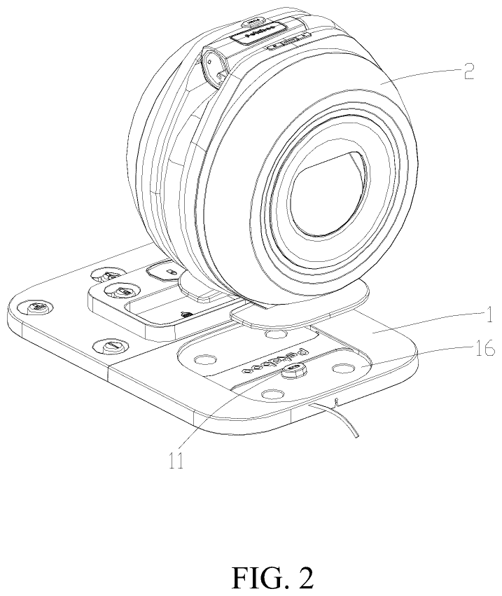

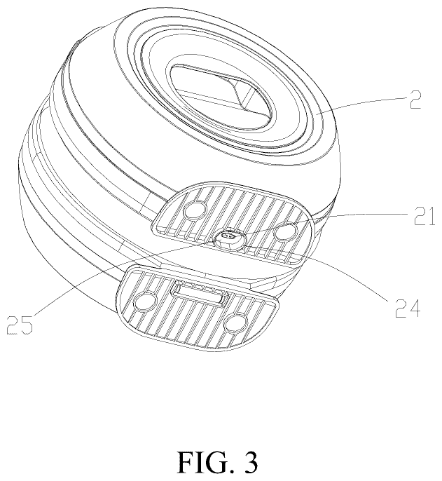

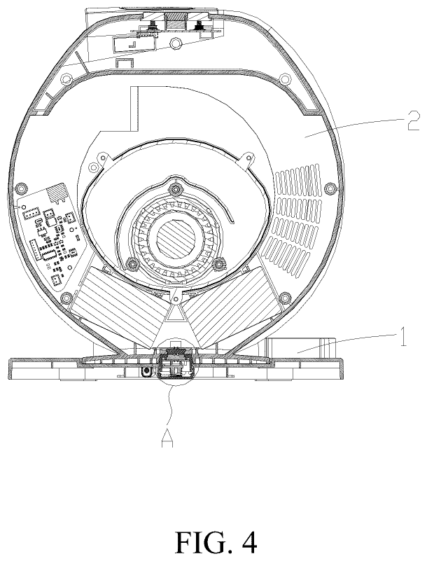

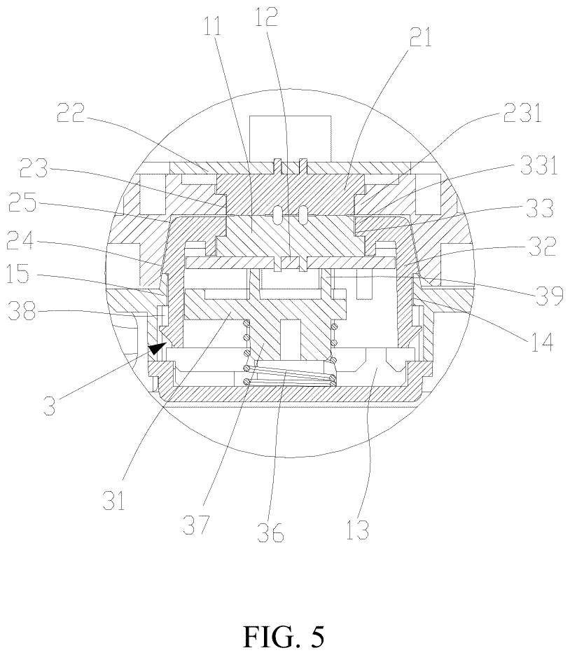

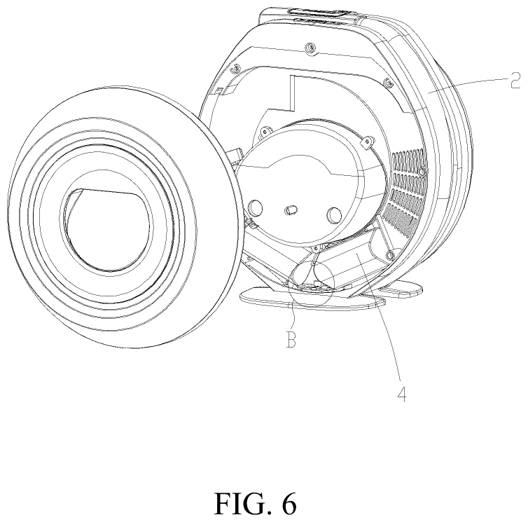

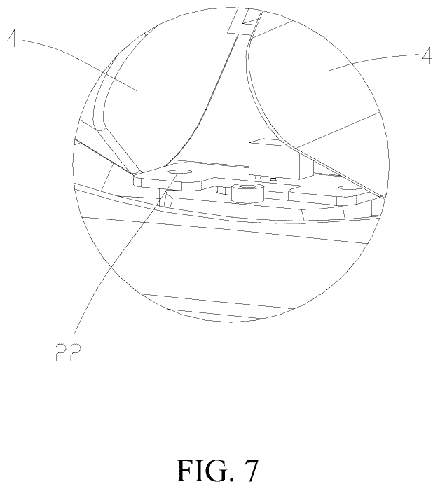

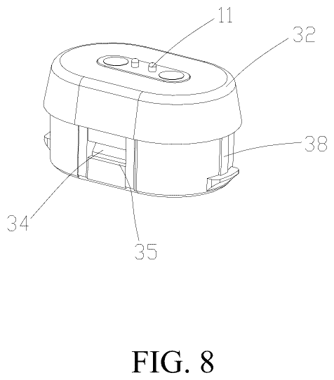

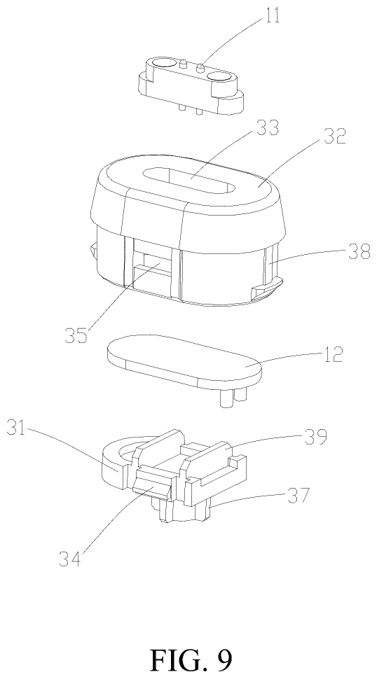

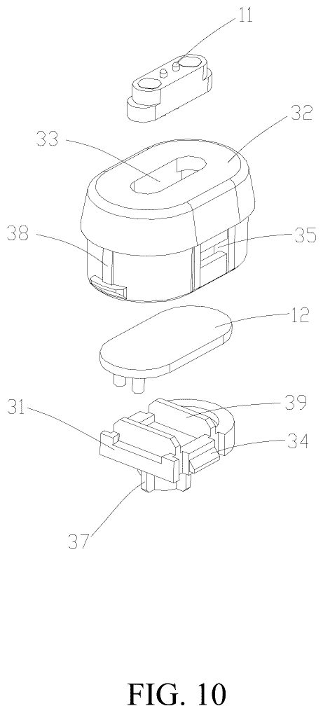

Referring to FIGS. 1 to 10, a charging structure for a hair grooming device includes a charging base 1, a grooming device host 2 and an elastic mechanism 3. The charging base 1 is provided with a first electrical contact 11 configured to electrically connect to an external power source. The grooming device host 2 is provided with a built-in power supply 4 and a second electrical contact 21. The second electrical contact 21 is electrically connected to the built-in power supply 4. When the first electrical contact 11 of the charging base 1 contacts the second electrical contact 21 of the grooming device host 2, the elastic mechanism 3 applies elastic adjustment to the first electrical contact 11 or the second electrical contact 21, thus establishing an elastic connection between the first electrical contact 11 and the second electrical contact 21.

The beneficial effects of the present disclosure are as follows. Through the above structural configuration, a built-in power supply is integrated into the grooming device host, thereby providing electricity to electronic components within the host, eliminating the need for external mains electricity connection. This design simplifies the structure and enhances operational convenience. Additionally, the charging base facilitates efficient charging of the grooming device host. During use, bringing the first electrical contact of the charging base into contact with the second electrical contact of the grooming device host enables charging of the grooming device host, thereby providing a convenient charging solution. Furthermore, through the arrangement of the elastic mechanism, elastic adjustment is enabled when the first electrical contact and the second electrical contact come into contact, ensuring stable and reliable electrical contact between the first electrical contact and the second electrical contact.

In the present embodiment, the elastic mechanism 3 is disposed on the charging base 1. The elastic mechanism 3 is configured to apply elastic adjustment to the first electrical contact 11, thereby establishing an elastic connection between the first electrical contact 11 and the second electrical contact 21. This configuration facilitates charging operation of the grooming device host 2 with a simplified and rational structural design.

The charging base 1 includes a first circuit board 12. The first circuit board 12 is disposed on the elastic mechanism 3. The first electrical contact 11 is arranged on the first circuit board 12. The first circuit board 12 is configured to electrically connect to an external power source, such that the first electrical contact 11 is electrically connected to the external power source.

Specifically, the elastic mechanism 3 includes a base member 31 and a cover member 32. The cover member 32 is configured to clamp and fix the first circuit board 12 onto the base member 31. The cover member 32 defines a first through hole 33. The first electrical contact 11 on the first circuit board 12 extends through the first through hole 33 to be exposed outside the cover member 32. This structural arrangement securely positions the first circuit board 12 (and the first electrical contact 11), simplifying structural design and assembly. Furthermore, the base member 31 is provided with a protrusion 39, and the first circuit board 12 is disposed on the protrusion 39 to enable effective heat dissipation. An inner wall of the first through hole 33 is provided with a first retaining protrusion 331 to prevent the first electrical contact 11 from disengaging from the first through hole 33, thereby significantly enhancing product reliability.

Furthermore, a snap-fit protrusion 34 is disposed on a sidewall of the base member 31. Correspondingly, a snap-fit aperture 35 is defined in a sidewall of the cover member 32. The snap-fit protrusion 34 interlocks with the snap-fit aperture 35 to connect the base member 31 and the cover member 32, thereby achieving a simplified structural design and convenient assembly.

Furthermore, the elastic mechanism 3 includes a spring 36. The charging base 1 is provided with an installation cavity 13. The base member 31 is disposed within the installation cavity 13. A first end of the spring 36 abuts against the base member 31, and a second end of the spring 36 abuts against a bottom wall of the installation cavity 13. The installation cavity 13 defines an opening 14. The cover member 32 protrudes through the opening 14 to be exposed outside the installation cavity 13. This structural arrangement enables the elastic mechanism 3 to achieve effective elastic adjustment, thereby providing a simplified structure and rational design. The bottom wall of the installation cavity 13 is detachable, thereby facilitating assembly of the elastic mechanism 3.

The base member 31 is provided with a positioning post 37. A first end of the spring 36 is sleeved over the positioning post 37, thereby effectively enhancing structural stability of the product.

Furthermore, an inner wall of the opening 14 is provided with a stopper block 15. Correspondingly, an outer wall of the cover member 32 is provided with a stopper slot 38. The stopper block 15 is disposed within the stopper slot 38 to limit an elastic adjustment travel of the spring 36, ensuring that the first electrical contact 11 performs elastic adjustment within an effective travel range, thereby improving product reliability.

In this embodiment, the grooming device host 2 comprises a second circuit board 22. The second electrical contact 21 is disposed on the second circuit board 22. The second circuit board 22 is electrically connected to the built-in power supply 4, thereby electrically connecting the second electrical contact 21 to the built-in power supply 4.

The grooming device host 2 defines a second through hole 23. The second electrical contact 21 on the second circuit board 22 protrudes through the second through hole 23 to be exposed outside the grooming device host 2. Additionally, an inner wall of the second through hole 23 is provided with a second retaining protrusion 231 to prevent detachment of the second electrical contact 21 from the second through hole 23, effectively enhancing product reliability.

Furthermore, an annular positioning protrusion 24 is disposed around an periphery of the second through hole 23 of the grooming device host 2. The annular positioning protrusion 24 encloses a positioning space 25. A shape of the positioning space 25 corresponds to a shape of the cover member 32. On one hand, during charging operation, the positioning space 25 provides a guiding function to facilitate alignment. On the other hand, the positioning protrusion 24 isolates the first electrical contact 11 and the second electrical contact 21 from external environments during charging, thereby preventing accidental electric leakage.

In this embodiment, the charging base 1 is further provided with a positioning slot 16. A shape of the positioning slot 16 corresponds to a shape of a bottom portion of the grooming device host 2. The first electrical contact 11 is disposed within the positioning slot 16, thereby facilitating positional constraint of the grooming device host 2 during charging. This configuration achieves a simplified structure and user-friendly operation.

The above are only preferred embodiments of the present disclosure and are not intended to limit the present disclosure, and any modification, equivalent replacement and improvement made within a spirit and a principle of the present disclosure shall fall within a protection scope of the present disclosure.

What is claimed is:

1. A charging structure for a hair grooming device, comprising:
a charging base provided with a first electrical contact, wherein the first electrical contact is configured to electrically connect to an external power source;
a grooming device host provided with a built-in power supply and a second electrical contact, wherein the second electrical contact is electrically connected to the built-in power supply; and
an elastic mechanism, wherein the elastic mechanism is configured to apply elastic adjustment to the first electrical contact or the second electrical contact to establish an elastic connection between the first and second electrical contacts when the first electrical contact contacts the second electrical contact.

2. The charging structure according to claim 1, wherein the elastic mechanism is disposed on the charging base, the elastic mechanism is configured to apply the elastic adjustment to the first electrical contact to establish the elastic connection with the second electrical contact.

3. The charging structure according to claim 2, wherein the charging base comprises a first circuit board disposed on the elastic mechanism, the first electrical contact is arranged on the first circuit board, and the first circuit board is configured to electrically connected to the external power source, thereby enabling electrical connection of the first electrical contact and the external power source.

4. The charging structure according to claim 3, wherein the elastic mechanism comprises a base member and a cover member, the cover member covers and secures the first circuit board to the base member, the cover member defines a first through hole, the first electrical contact protrudes through the first through hole to be exposed outside the cover member.

5. The charging structure according to claim 4, wherein a sidewall of the base member is provided with a snap-fit protrusion, a sidewall of the cover member is provided with a snap-fit aperture, and the snap-fit protrusion interlocks with the snap-fit aperture to connect the base member and the cover member.

6. The charging structure according to claim 4, wherein the elastic mechanism further comprises a spring, the charging base defines an installation cavity, the base member is disposed within the installation cavity, a first end of the spring abuts against the base member, a second end of the spring abuts against a bottom wall of the installation cavity, the installation cavity defines an opening, and the cover member protrudes through the opening to be exposed outside the installation cavity.

7. The charging structure according to claim 6, wherein the base member is provided with a positioning post, and the first end of the spring is sleeved over the positioning post.

8. The charging structure according to claim 6, wherein an inner wall of the opening is provided with a stopper block, an outer wall of the cover member is provided with a stopper slot; and the stopper block is disposed within the stopper slot to limit an elastic adjustment travel of the spring.

9. The charging structure according to claim 8, wherein the grooming device host comprises a second circuit board, the second electrical contact is disposed on the second circuit board, and the second circuit board is electrically connected to the built-in power supply, thereby enabling electrical connection of the second electrical contact and built-in power supply.

10. The charging structure according to claim 9, wherein the grooming device host defines a second through hole, the second electrical contact protrudes through the second through hole to be exposed outside the grooming device host; an annular positioning protrusion is disposed on the grooming device host around a periphery of the second through hole, and the annular positioning protrusion encloses a positioning space having a shape complementary to a shape of the cover member.

11. The charging structure according to claim 4, wherein the grooming device host comprises a second circuit board, the second electrical contact is disposed on the second circuit board, and the second circuit board is electrically connected to the built-in power supply, thereby enabling electrical connection of the second electrical contact and built-in power supply.

12. The charging structure according to claim 11, wherein the grooming device host defines a second through hole, the second electrical contact protrudes through the second through hole to be exposed outside the grooming device host; an annular positioning protrusion is disposed on the grooming device host around a periphery of the second through hole, and the annular positioning protrusion encloses a positioning space having a shape complementary to a shape of the cover member.
